(19) United States
(12) Patent Application Publication
(10) Pub. No.: US 2021/0251287 A1
(43) Pub. Date: Aug. 19, 2021

(54) AEROSOL-GENERATING ARTICLE WITH ABSORBENT CARRIER

(71) Applicant: PHILIP MORRIS PRODUCTS S.A., Neuchâtel (CH)

(72) Inventors: Robert Emmett, Neuchâtel (CH); Ana Isabel Gonzalez Florez, St. Sulpice (CH)

(21) Appl. No.: 17/269,744

(22) PCT Filed: Aug. 22, 2019
(86) PCT No.: PCT/IB2019/057085

§ 371 Date: Feb. 19, 2021

(30) Foreign Application Priority Data
Aug. 30, 2018 (EP) 18191828.5

(51) Int. Cl. A24F 40/42; A24F 40/20

(52) U.S. Cl. CPC A24F 40/42; A24D 1/20; A24F 40/20

(57) ABSTRACT

An aerosol-generating article (500) includes an aerosol-forming substrate (511) and an absorbent carrier (512) impregnated or impregnatable with an aerosol former. The aerosol-generating article may be received in an aerosol-generating device that includes a heating element for heating the aerosol-forming substrate. The system may be configured such that the absorbent carrier is disposed between the aerosol-forming substrate and the heating element. As the aerosol generating article is heated, the aerosol former impregnated in the absorbent carrier may improve aerosol formation.

This disclosure relates to aerosol-generating devices and to aerosol-generating articles comprising an aerosol-forming substrate for use in the aerosol-generating devices; and more particularly, to an absorbent carrier and an aerosol former for use in such aerosol-generating articles.

Traditional smoking articles, such as cigarettes and cigars, include tobacco that is combusted to generate smoke that is inhaled by a consumer. One way to reduce the production of carbon monoxide and other combustion by-products is to use electric heaters that heat the tobacco substrate to a temperature sufficient to produce an aerosol from the substrate without combusting the substrate. Such heat-not-burn smoking articles reduce or eliminate by-products associated with combustion of tobacco. However, such devices may suffer from a reduction in aerosol production compared to traditional smoking articles that combust tobacco. Some aerosol-generating devices have been proposed that employ e-liquids rather than tobacco. Aerosol-generating devices that employ e-liquids eliminate combustion by-products but deprive consumers of the traditional tobacco-based experience.

To experience the traditional flavor and smoking experience, users may prefer electrically heated smoking articles that include a substrate comprising tobacco. The electrically heated smoking articles may include either tobacco without an e-liquid or with an e-liquid (also known as hybrid aerosol-generating elements).

In some known types of aerosol-generating device, aerosol is generated by the transfer of heat from a heat source to a physically separate aerosol-generating article that includes, for example, a substrate containing tobacco. The device is configured such that the heat source does not combust the substrate. During use, volatile compounds are released from the aerosol-forming substrate by heat transfer from the heat source and are entrained in air drawn through the aerosol-generating article. As the released compounds cool, they condense to form an aerosol that is inhaled by the user.

Production of aerosol may refer to any of: visible aerosol, aerosol mass, aerosol volume, or any combination thereof. Some electrically heated aerosol-generating devices that use a tobacco-based substrate may not meet a user's expectation of a traditional smoking experience due to reduced production of aerosol. For example, production of aerosol may begin more slowly such that it may take longer for the user to be able to take a first puff. The user may also experience reduced production of aerosol, which may be more pronounced during initial puffs. The reduced production of aerosol may be due to inefficient heat conduction between the heater and the tobacco-based substrate. Inefficient heat conduction between an electric heater and the substrate may result in an overall low amount of total aerosol matter (TAM), particularly during the first ˜3-4 puffs.

It would be desirable to provide an aerosol-generating article for use in electrically heated aerosol-generating devices that improves aerosolization. It would be desirable to provide an aerosol-generating article for use in electrically heated aerosol-generating devices that increases the total aerosol mass. It would be desirable to provide an aerosol-generating article for use in electrically heated aerosol-generating devices that reduces the time until a user may take a first puff (time to first puff, also referred to as TT1P). It would further be desirable to provide an aerosol-generating system that allows for the use of tobacco as the aerosol-forming substrate in an electrically heated aerosol-generating device while one or more of improving aerosolization, increasing TAM, and decreasing TT1P.

Various aspects of the invention relate to aerosol-generating systems that use an electrically heated heating element that is configured to heat but not burn the aerosol-forming substrate. The aerosol-forming substrate may be provided as part of an aerosol-generating article that may be received by the device. The aerosol-generating article may comprise an absorbent carrier. A volatile aerosol former is impregnated or may be impregnatable in the absorbent carrier. The absorbent carrier may be disposed adjacent the aerosol-forming substrate. The absorbent carrier may be disposed adjacent the heating element. The absorbent carrier may be disposed adjacent both the aerosol-forming substrate and the heating element. The aerosol generating article and the aerosol former in the absorbent carried are heated during use. The presence of aerosol formers in the gas phase enhances the condensation of the compounds volatilized from the aerosol generating article, thereby improving the formation of aerosol.

According to an aspect of the present disclosure, an absorbent carrier impregnated (or impregnatable) with an aerosol former is provided as part of the aerosol-generating article. The absorbent carrier impregnated (or impregnatable) with an aerosol former may improve aerosolization and the release of sensory active compounds from the aerosol-forming substrate. The absorbent carrier may be impregnated with one or more aerosol formers. Optionally, the absorbent carrier may also be impregnated with one or more sensory active compounds or precursors thereof. An aerosol former is a compound which, in use, facilitates formation of an aerosol. Such compounds include, although are not limited to glycerine and propylene glycol. A sensory active compound is a compound that allows triggering of a sensory response, for example a flavor. The aerosol-generating article may be arranged for use with an aerosol-generating device. The aerosol-generating device is configured receive the aerosol-generating article and to heat the aerosol-forming substrate and the absorbent carrier of the aerosol-generating article.

The absorbent carrier may be in the form of a sheet. The term “sheet” is used here to refer to a material that is generally flat and has a width and height that are greater (for example, orders of magnitude greater) than the thickness of the material. An example of a sheet is a sheet of paper. It will be understood that the term “sheet” may also encompasses materials with a greater thickness than paper.

The absorbent carrier may comprise fibers and may be made of paper or another cellulose-based sheet material.

In some embodiments the aerosol former is impregnated into the absorbent carrier. In some embodiments, the volatile aerosol former is impregnatable, and may be provided separately from the absorbent carrier to be impregnated prior to use. For example, a user may cause the aerosol former to be impregnated in the absorbent carrier. In some embodiments, the aerosol former may be provided inside a breakable element. The breakable element may be broken by the user just before the intended use of the article. For example, the aerosol-generating article may comprise a frangible membrane housing the aerosol-former. The frangible membrane may be arranged relative to the absorbent carrier so that when the frangible membrane is ruptured, the aerosol-former is released and absorbed by the absorbent carrier. For example, a user may apply a force, for example by squeezing, pressing or shaking, etc. the aerosol-generating article. The use of the aerosol-formers may therefore be activated as desired by a user.

When the aerosol-forming substrate and the absorbent carrier of the aerosol-generating article are heated during use, the aerosol former impregnated into (for example, absorbed into) the absorbent carrier partially or entirely vaporizes. The vaporized compounds contribute to the formation of the aerosol. The aerosol former may improve aerosolization by increasing the total aerosolized matter generated by the aerosol-generating device, particularly during the first few puffs. As such, aerosol production more similar to combusting smoking articles may be obtained with the aerosol-generating device using tobacco-based substrate and employing the absorbent carrier impregnated with an aerosol former. This helps preserve as much as possible of the flavors, aromas, and the rituals associated with traditional smoking. Without the absorbent carrier impregnated with a volatile aerosol former, heat-not-burn aerosol-generating systems may yield a relatively low amount of total aerosol mass, particularly during the first few puffs, compared to a conventional smoking.

The term “aerosol” is used here to refer to a suspension of fine solid particles or liquid droplets in a gas, such as air, which may contain volatile flavor compounds.

The absorbent carrier may act as a carrier or support for volatile compounds such as the aerosol former. Use of the absorbent carrier impregnated with a volatile aerosol former in the aerosol-generating article may reduce the time to first puff, increases the total aerosol matter (TAM), or both reduce the time to first puff and increase TAM. TAM is preferentially increased particularly during the first few puffs because it is usually the first few puffs where TAM is low with electrically heated aerosol-generating devices. The aerosol-generating article may be arranged for use with a heating element. The heating element may be arranged to heat the aerosol-forming substrate of the aerosol-generating article. The heating element may be arranged to heat the absorbent carrier of the aerosol-generating article. The heating element may be arranged to heat both the aerosol-forming substrate of the aerosol-generating article and the absorbent carrier of the aerosol-generating article.

According to some embodiments, the absorbent carrier, impregnated or impregnatable with an aerosol former, may be placed adjacent a heating element. The heating element may be placed closer to the absorbent carrier than the substrate so that the aerosol former in the absorbent carrier reaches volatilization temperature first before the substrate.

In some embodiments, the heating element may comprise an external heating element. The external heating element may be arranged to heat the aerosol-generating article externally, for example, from an outer surface of the aerosol-generating article.

In some embodiments, the aerosol-forming substrate may form a core that is at least partially surrounded by the absorbent carrier. The aerosol-forming substrate may form a core that is circumscribed by the absorbent carrier. The absorbent carrier may be disposed between the aerosol-forming substrate core and the heating element, which may be an external heating element.

In some embodiments, the heating element may comprise an internal heating element. The internal heating element may be arranged to at least partially penetrate at least a portion of the aerosol-generating article. In use, the internal heating element may be aligned with a longitudinal axis of the aerosol-generating article.

In some embodiments, the absorbent carrier may form a core that is at least partially surrounded by the aerosol-forming substrate. The absorbent carrier may form a core that is circumscribed by the aerosol-forming substrate. The absorbent carrier core may be disposed between the aerosol-forming substrate and the heating element, which may be an internal heating element. For example, the internal heating element may be at least partially surrounded by the absorbent carrier. The internal heating element may be circumscribed by the absorbent carrier. The absorbent carrier may be disposed adjacent the aerosol-forming substrate and the heating element.

In some embodiments, the absorbent carrier may define a hollow region, through hole, or slot for receiving the internal heating element.

The heating element may comprise both an internal heating element and an external heating element. In use, the aerosol-forming substrate may be disposed at least partially within the external heating element and at least partially surrounding the internal heating element. The absorbent carrier may be disposed between the aerosol-forming substrate and the external heating element. The absorbent carrier may be disposed between the aerosol-forming substrate and the internal heating element. The absorbent carrier may be disposed both between the aerosol-forming substrate and the external heating element and also disposed between the aerosol-forming substrate and the internal heating element. The absorbent carrier may be disposed adjacent the aerosol-forming substrate and adjacent the external heating element. The absorbent carrier may be disposed adjacent the aerosol-forming substrate and the internal heating element. The absorbent carrier may be disposed adjacent the aerosol-forming substrate and both the external heating element and the internal heating element.

In some embodiments, the heating element may be provided as part of the aerosol-generating device. In some embodiments, the heating element may be provided as part of the aerosol-generating article. In some embodiments, the heating element may be provided both as part of the aerosol-generating article and as part of the aerosol-generating device. Where the heating element comprises both an internal heating element and an external heating element, one or both of the internal and external heating elements may be provided as part of the aerosol-generating article. Where the heating element comprises both an internal heating element and an external heating element, one or both of the internal and external heating elements may be provided as part of the aerosol-generating device.

The aerosol-generating device may be configured to heat the absorbent carrier and the aerosol-forming substrate in the aerosol-generating article by conduction. The aerosol-generating article is preferably shaped and sized to allow contact with, or minimize distance from, the heating element to provide efficient heat transfer from the heating element to the absorbent carrier and the aerosol-forming substrate in the aerosol-generating article. The heat may be generated by any suitable mechanism, such as by resistive heating or by induction.

In some embodiments, the aerosol-generating article is heated by inductive heating. In order to facilitate inductive heating, the aerosol-generating article or the aerosol-generating device or both the aerosol-generating article and the aerosol-generating device may be provided with a susceptor. Suitable susceptor materials comprise or be made of graphite, molybdenum, silicon carbide, niobium, INCONEL® alloys (austenitic nickel-chromium-based superalloys), metallized films, ceramics such as for example zirconia, transition metals such as for example Fe, Co, Ni, or metalloids components such as for example B, C, Si, P, Al.

In embodiments that are inductively heated, the susceptor may take any suitable form or shape. For example, the susceptor may comprise a powder, shreds, strips, a sheet, a plug, a block, a blade, a random shape, etc., or a combination thereof. The susceptor may be a part of the aerosol-generating article. For example, the susceptor may be a part of a wrapper or liner. The susceptor may comprise an insert. The susceptor may be distributed throughout the aerosol-generating article. In some embodiments, the susceptor comprises a combination of a wrapper, liner, insert, or material distributed throughout the substrate. In one embodiment, the aerosol-generating article body may be made from a material (for example, aluminum) that is capable of acting as a susceptor. In another embodiment, a susceptor material is provided within the cavity of the aerosol-generating article. For example, the susceptor material may be homogenously distributed throughout the substrate. A susceptor material may be provided as part of the aerosol-generating article in any form, for example a powder, shreds, strips, a sheet, a plug, a block, a blade, a random shape, etc., or a combination thereof. In some embodiments, the susceptor is part of the aerosol-generating device. For example, the aerosol-generating device may comprise an internal heater that comprises a susceptor, such as a blade of susceptor material. The aerosol-generating device may comprise an external heater that comprises a susceptor. In an embodiment, an internal wall of a heating chamber may be provided with susceptor material, such as a susceptor coating or lining. In order to inductively heat the susceptor material, the aerosol-generating device may comprise a coil to generate an alternating current to cause susceptor to heat.

The aerosol-generating article may be provided in any suitable shape, configured to be received by the aerosol-generating device. The aerosol-generating device may be a smoking article, such as a generally rod-shaped smoking article or an article having any other suitable shape. The aerosol-generating article may be configured to be received by a shisha device. The aerosol-generating article may have a substantially cuboidal shape, cylindrical shape, frustro-conical shape, or any other suitable shape. Preferably, the aerosol-generating article has a generally cylindrical shape, such as an elongated cylindrical shape, or a frustro-conical shape.

The aerosol-generating article may be a cartridge. The cartridge may comprise any suitable body defining a cavity in which the aerosol-forming substrate is disposed. The body is preferably formed from one or more heat resistant materials, such as a heat resistant polymer or metal. The body may comprise a thermally conductive material. For example, the body may comprise any of: aluminum, copper, zinc, nickel, silver, any alloys thereof, and combinations thereof. Preferably, the body comprises aluminum.

The body may comprise a sidewall. According to an embodiment, the sidewall forms a cylinder defining a cavity. The cylinder may comprise a varying diameter, for example a diameter arranged to taper towards one end of the cylinder. The cylindrical sidewall may have first and second ends. The first and second ends may be open ends. The body may also comprise one or more end walls at least partially covering the ends of the cylindrical side wall. In some embodiments, the body comprises a cylindrical sidewall that is open at one end and closed at the other end or is open at both ends. The body may comprise one or more parts. For example, the sidewall and an end wall may be an integral single part. The sidewall and the end wall may be two parts configured to engage one another in any suitable manner, such as threaded engagement or interference fit. The sidewall and the end wall may be two parts joined together, for example by welding or by an adhesive. The sidewall and two opposite end walls may be three separate parts configured to engage one another in any suitable manner, such as threaded engagement interference fit, welding, or an adhesive.

The body defines a cavity in which the aerosol-forming substrate and the absorbent carrier may be disposed. A portion of the body defining the cavity may comprise a heatable wall or surface. As used herein, “heatable wall” and “heatable surface” mean an area of a wall or a surface to which heat may be applied, either directly or indirectly. The heatable wall or surface may function as a heat transfer surface. For example, the heatable wall or surface of the portion of the body defining the cavity is a surface through which heat may be transferred from outside of the cavity through the body to the cavity or to an internal surface of the cavity. In some embodiments, the aerosol-generating article is configured to receive an internal heating element. For example, an elongated heating element, such as a rod, blade, or pin, may be inserted into the aerosol-generating article as the aerosol-generating article is inserted into the aerosol-generating device. The elongated heating element may be part of the aerosol-generating device or may be provided as a separate element that couples with the aerosol-generating device.

The absorbent carrier, impregnated or impregnatable with an aerosol former, may be placed adjacent an internal surface of a cavity of an aerosol-generating device. The absorbent carrier may be placed adjacent both the internal surface of the cavity and the heating element. The aerosol-generating article may be configured so that the absorbent carrier is in contact with or adjacent the heatable surface when the aerosol-generating article is in use. In one embodiment, the absorbent carrier is in direct contact with the heatable surface when the aerosol-generating article is in use.

The aerosol-forming substrate of the aerosol-generating article may occupy any suitable volume of the article. Where the aerosol-generating article comprises a cartridge, the aerosol-forming substrate may occupy any suitable volume of the cavity of the article. The volume of the aerosol-forming substrate in the aerosol-generating article may be varied by altering the amount, composition, shape, packing density, or format of the aerosol-forming substrate placed in the aerosol-generating article.

Any suitable aerosol-forming substrate may be provided as part of the aerosol-generating article. The aerosol-forming substrate is preferably a substrate capable of releasing volatile compounds that may form an aerosol. The volatile compounds may be released by heating the aerosol-forming substrate. The aerosol-forming substrate may be solid, paste, gel, slurry, liquid, or may comprise any combination of any two or more of: solid, paste, gel, slurry, and liquid components.

The aerosol-forming substrate may comprise nicotine. The nicotine containing aerosol-forming substrate may comprise a nicotine salt matrix. The aerosol-forming substrate may comprise plant-based material. The aerosol-forming substrate preferably comprises tobacco, and preferably the tobacco containing material contains volatile tobacco flavor compounds, which are released from the aerosol-forming substrate upon heating. The aerosol-forming substrate may comprise homogenized tobacco material. Homogenized tobacco material may be formed by agglomerating particulate tobacco. The aerosol-forming substrate may alternatively or additionally comprise a non-tobacco-containing material. The aerosol-forming substrate may comprise homogenized plant-based material.

The aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, homogenized tobacco, extruded tobacco and expanded tobacco.

The aerosol-forming substrate may comprise at least one aerosol former, which may be the same or different from the aerosol former impregnated into the absorbent carrier. The aerosol former may be any suitable known compound or mixture of compounds which, in use, facilitates formation of a dense and stable aerosol and which is substantially resistant to thermal degradation at the operating temperature of the aerosol-generating device. Suitable aerosol formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Particularly preferred aerosol formers are polyhydric alcohols or mixtures thereof, such as triethylene glycol, 1,3-butanediol and, most preferred, glycerine. The aerosol-forming substrate may comprise other additives and ingredients, such as flavorants. The aerosol-forming substrate preferably comprises nicotine and at least one aerosol former. In some embodiments, the aerosol former is glycerine or a mixture of glycerine and one or more other suitable aerosol formers, such as those listed above.

The aerosol-forming substrate may comprise any suitable amount of an aerosol former. For example, the aerosol former content may be equal to or greater than 5% of the aerosol-forming substrate on a dry weight basis, and preferably between greater than 30% by weight on a dry weight basis. The aerosol former content may be less than about 95% on a dry weight basis. Preferably, the aerosol former content is up to about 55%.

The aerosol-forming substrate may be provided on or embedded in a thermally stable carrier. The term “thermally stable” is used here to indicate a material that does not substantially degrade at temperatures to which the substrate is typically heated (for example, about 150° C. to about 300° C.). The thermally stable carrier may be separate and distinct from the absorbent carrier. The thermally stable carrier may be used to provide support for the aerosol-forming substrate (for example, molasses). The aerosol-forming substrate and thermally stable carrier may be disposed in the center of the aerosol-generating article. The absorbent carrier, on the other hand, may be used as a carrier for an aerosol former. The absorbent carrier and the aerosol former may be placed adjacent the side walls, end wall, bottom, or both, of the aerosol-generating article. The absorbent carrier and the aerosol former may at least partially surround the aerosol-forming substrate and thermally stable carrier.

The thermally stable carrier may comprise a thin layer on which the substrate deposited on a first major surface, on a second major surface, or on both the first and second major surfaces. The thermally stable carrier may be formed of, for example, paper or paper like material, a non-woven carbon fiber mat, a low mass open mesh metallic screen, or a perforated metallic foil or any other thermally stable polymer matrix. Alternatively, the thermally stable carrier may take the form of powder, granules, pellets, shreds, spaghettis, strips or sheets. The carrier may be a non-woven fabric or fiber bundle into which tobacco components have been incorporated. The non-woven fabric or fiber bundle may comprise, for example, carbon fibers, natural cellulose fibers, or cellulose derivative fibers. In some embodiments the carrier may be omitted.

In some examples, the aerosol-forming substrate comprises one or more sugars in any suitable amount. Particularly, if the aerosol-generating device is a shisha device, it may be desirable that the aerosol-forming substrate comprises one or more sugars. Preferably, the aerosol-forming substrate comprises invert sugar, which is a mixture of glucose and fructose obtained by splitting sucrose. Preferably, the aerosol-forming substrate comprises from about 1% to about 40% sugar, such as invert sugar, by weight. In some example, one or more sugars may be mixed with a suitable carrier such as cornstarch or maltodextrin. In some embodiments the aerosol-forming substrate is free of added sugar.

In some examples, the aerosol-forming substrate comprises one or more sensory-enhancing agents. Suitable sensory-enhancing agents include flavorants and sensation agents, such as cooling agents. Suitable flavorants include natural or synthetic menthol, peppermint, spearmint, coffee, tea, spices (such as cinnamon, clove, ginger, or combination thereof), cocoa, vanilla, fruit flavors, chocolate, eucalyptus, geranium, eugenol, agave, juniper, anethole, linalool, and any combination thereof.

In some examples, the aerosol-forming substrate is in the form of a suspension. For example, the aerosol generating substrate may comprise molasses. Particularly, if the aerosol-generating device is a shisha device, the aerosol-forming substrate may comprise molasses. As used herein, “molasses” means an aerosol-forming substrate composition comprising about 20% or more sugar. For example, the molasses may comprise at least about 25% by weight sugar, such as at least about 35% by weight sugar. Typically, the molasses will contain less than about 60% by weight sugar, such as less than about 50% by weight sugar.

Aerosol-forming substrates for use with traditional shisha devices may be in the form of a molasses, which may be nonhomogeneous and may contain lumps and cavities. Such cavities prevent direct thermal contact between the substrate and a heated surface making thermal conduction particularly inefficient. As a consequence, electronic heated shisha devices tend to depart from traditional molasses by using, for example, e-liquids or dry stones. Due to the use of an absorbent carrier impregnated with a volatile aerosol former in the aerosol-generating article as described in the present disclosure, more traditional aerosol-forming substrates, such as molasses, may be used to preserve the typical ritual and shisha experience while using electric heating. The various substrates may be used interchangeably such that a traditional shisha substrate may be used in a non-shisha aerosol-generating article, and a non-shisha substrate may be used in a cartridge intended for use in a shisha device.

Any suitable amount of aerosol-forming substrate (for example, molasses or tobacco substrate) may be provided as part of the aerosol-generating article. The aerosol-generating article may include at least 0.4 g, at least 0.5 g, at least 0. 8 g, at least 1 g, at least 1.5 g, at least 2 g, or at least 2.5 g of aerosol-forming substrate. The aerosol-generating article may include up to 15 g, up to 10 g, up to 5 g, or up to 4 g of aerosol-forming substrate. In one embodiment, about 10 g of aerosol-forming substrate is provided. The aerosol-forming substrate may be disposed within a space defined by the absorbent carrier.

The aerosol-generating article may have any suitable size. For example, the aerosol-generating article may have a length of about 15 cm or less, about 12 cm or less, about 10 cm or less, about 8 cm or less, or about 6 cm or less. The length may be about 1 cm or greater, about 3 cm or greater, about 4 cm or greater, or about 5 cm or greater. The aerosol-generating article may have an outer diameter of about 5 mm or greater, about 6 mm or greater, about 7 mm or greater, or about 8 mm or greater. The outer diameter may be about 20 mm or less, about 15 mm or less, about 12 mm or less, or about 10 mm or less. Where the aerosol-generating article comprises a cartridge, the body of the cartridge may have a heatable surface area in the cavity. The heatable surface area in the cavity may be from about 4 cm² or greater, about 6 cm² or greater, about 8 cm² or greater, or about 10 cm² or greater. The heatable surface area may be about 50 cm² or less, about 40 cm² or less, about 30 cm² or less, or about 20 cm² or less. In a preferred embodiment, the body is cylindrical.

If the aerosol-generating article is a cartridge, such as a shisha cartridge, the body of the cartridge may have a length of about 15 cm or less. The cartridge may have an inner diameter of about 1 cm or more. The cartridge may have a heatable surface area in the cavity from about 25 cm² to about 100 cm², such as from about 70 cm² to about 100 cm². The volume of the cavity may be from about 10 cm³ to about 50 cm³. The body may have a heatable surface area in the cavity from about 20 cm² to about 100 cm². Preferably, the body is cylindrical or frustro-conical.

Preferably, the aerosol-generating article comprises an amount of aerosol-forming substrate that will provide a sufficient amount of aerosol for a smoking experience lasting from about 1 minute to about 60 minutes. In some embodiments, the amount of aerosol-forming substrate is sufficient for a smoking experience of at least about 30 seconds, at least about 1 minutes, at least about 1.5 minutes, at least about 2 minutes, or at least about 3 minutes. The amount of aerosol-forming substrate may be sufficient for a smoking experience of up to 10 minutes, up to 8 minutes, up to 6 minutes, or up to 5 minutes. If the device is a shisha device, the smoking experience preferably lasts from about 20 minutes to about 50 minutes; and more preferably from about 30 minutes to about 40 minutes.

The aerosol-generating article may be provided as a flow-through element. The aerosol-generating article may be defined by one or more walls. For example, the aerosol-generating article may have a cylindrical wall with an open end or open first and second ends. The aerosol-generating article may have a cylindrical wall with one or more side walls covering the first and second ends. The aerosol-generating article may include ventilation holes in the cylindrical wall, at the first end, at the second end, or a combination thereof.

The aerosol-generating article may comprise one or more ventilation holes. Particularly, if the aerosol-generating article is a cartridge, the aerosol-generating article may comprise one or more ventilation holes. The ventilation holes may be inlets or outlets, and may be disposed at the bottom, top, sides, or a combination thereof, of the aerosol-generating article. In some embodiments, the top of the aerosol-generating article may define one or more apertures to form the one or more inlets of the aerosol-generating article. The bottom of the aerosol-generating article may define one or more apertures to form the one or more outlets of the aerosol-generating article.

In some embodiments, the aerosol-generating article comprises one or more inlets and one or more outlets to allow air to flow through the aerosol-forming substrate when the aerosol-generating article is used in an aerosol-generating device. The one or more inlets and one or more outlets may include open ends of the aerosol-generating article or ventilation holes in the walls of the aerosol-generating article. Preferably, the one or more inlets and outlets are sized and shaped to provide a suitable resistance to draw (RTD) through the aerosol-generating article. In some examples, the RTD through the aerosol-generating article, from the inlet or inlets to the outlet or outlets, may be from about 10 mm H₂O to about 50 mm H₂O, preferably from about 20 mm H₂O to about 40 mm H₂O. The RTD of a specimen refers to the static pressure difference between the two ends of the specimen when it is traversed by an air flow under steady conditions in which the volumetric flow is 17.5 milliliters per second at the output end. The RTD of a specimen may be measured using the method set out in ISO Standard 6565:2002 with any ventilation blocked.

According to some embodiments of the present disclosure, the aerosol-generating article includes an absorbent carrier impregnated or impregnatable with an aerosol former provided as part of the aerosol-generating article. In some embodiments, the absorbent carrier impregnated or impregnatable with the aerosol-former is disposed inside the aerosol-generating article. The absorbent carrier may be selected to absorb the volatile compound and to act as a carrier or support that may hold the volatile compound in close proximity of or in contact with the heated surface of an aerosol-generating article or with a heating element. The absorbent carrier may at least partially surround the aerosol-forming substrate. The aerosol-forming substrate may at least partially surround the absorbent carrier.

According to an embodiment, the absorbent carrier is impregnated with one or more aerosol formers that may aid in forming aerosols as the absorbent carrier is heated. Suitable aerosol formers include, but are not limited to, polyols, glycol ethers, polyol ester, esters, and fatty acids. The aerosol former may comprise one or more of glycerol, propylene glycol, erythritol, 1,3-butylene glycol, tetraethylene glycol, triethylene glycol, triethyl citrate, propylene carbonate, ethyl laurate, triacetin, meso-Erythritol, a diacetin mixture, diethyl suberate, triethyl citrate, benzyl benzoate, benzyl phenyl acetate, ethyl vanillate, tributyrin, lauryl acetate, lauric acid, and myristic acid. Preferably, the aerosol former comprises compounds that are relatively highly volatile and exhibit relatively high hygroscopy. In some embodiments, the aerosol former comprises glycerol (for example, vegetable glycerine (VG)), propylene glycol, or a combination thereof.

The absorbent carrier may comprise any suitable amount of the one or more aerosol formers. For example, the absorbent carrier may include 0.3 g or greater, 0.5 g or greater, 0.8 g or greater, 1 g or greater, 1.2 g or greater, or 1.5 or greater of aerosol former. The absorbent carrier may include up to 8 g, up to 7 g, up to 6 g, up to 5.5 g, up to 5 g, up to 4.5 g, or up to 4 g of aerosol former. In one embodiment, the absorbent carrier includes between 0.5 and 5 g of aerosol former.

The aerosol former may be impregnated into the absorbent carrier. Alternatively or in addition, the aerosol former is impregnatable, and may be provided separately from the absorbent carrier. An aerosol former provided separately from the absorbent carrier may be impregnated into the absorbent carrier prior to use. For example, the aerosol former may be provided inside a breakable or frangible element, such as a bead or a capsule. Aerosol former may be released from the breakable or frangible element by the user just before the intended use of the article. The aerosol-generating article may include a frangible membrane housing the aerosol former. The frangible membrane may be arranged to release the aerosol-former into the absorbent carrier upon rupturing of the frangible membrane. In some embodiments, the frangible membrane or element may be ruptured by a user by squeezing or by applying light pressure to the aerosol-generating article in the region of the frangible membrane or element. In some embodiments, the frangible membrane or element may release the aerosol former upon vigorous shaking of the aerosol-generating article containing the frangible membrane or element.

The aerosol former impregnated into (for example, absorbed into) the absorbent carrier may increase the number of condensation nuclei available at the beginning of the smoking experience. An increase in the number of condensation nuclei available at the beginning of the smoking experience may cause aerosol generation to start faster, and for more aerosol to be generated, particularly during the first few puffs. For example, the absorbent carrier impregnated with an aerosol former may increase the amount of aerosol to be generated during the first 2, first 3, first 5, first 10, first 15, first 20, or first 30 puffs.

The use of the aerosol formers impregnated into the absorbent carrier may also reduce the time it takes for the aerosol-generating device to be ready for the first puff (i.e., the time to first puff, or TT1P) that includes a suitable or desired TAM (usually about 15 mg/puff). For example, the TT1P may be approximately 20 seconds when using aerosol-generating articles without an absorbent carrier impregnated with an aerosol former. However, by using aerosol formers impregnated into the absorbent carrier to increase the amount of aerosol available during the first few puffs, the TT1P may be reduced by at least about 2 seconds, at least about 5 seconds, at least about 10 seconds, or at least about 15 seconds. TT1P may be reduced by up to about 20 seconds, up to about 18 seconds, up to about 15 seconds, or up to about 10 seconds. With shisha devices using a pre-heat time of approximately 4 minutes, the TT1P may be approximately 17 minutes when using cartridges employing a molasses without an absorbent carrier impregnated with an aerosol former. By using aerosol formers impregnated into the absorbent carrier to increase the amount of aerosol available during the first few puffs, the TT1P of a shisha device may be reduced by about 1 minute to about 15 minutes.

The absorbent carrier may have any suitable form or shape. Preferably, the absorbent carrier forms a sheet. The sheet may be further formed into a suitable shape. For example, the absorbent carrier may include a cylindrical portion that at least partially lines the inside surface of the cylindrical wall of the aerosol-generating article, at least partially surrounds the aerosol-forming substrate, or both. In some embodiments, the absorbent carrier is coated with or surrounded by the aerosol-forming substrate. The absorbent carrier may further include a portion that covers another wall (such as an end wall) of the aerosol-generating article. The absorbent carrier may include portions that are flat (for example, planar), curved, rolled, folded, pleated, crimped, scrunched, bent, etc., or may include a combination of forms and shapes (for example, a flat portion and a pleated or bent portion). In one embodiment, the absorbent carrier has a rolled shape. For example, the absorbent carrier may be layered with aerosol-forming substrate and rolled into a spiral cylinder shape that includes a plurality of alternating layers of absorbent carrier and aerosol-forming substrate. The rolled-up cylindrical shape may be placed inside the aerosol-generating article.

The absorbent carrier may be made from a porous material. In some embodiments, the absorbent carrier comprises fibers. The absorbent carrier may be made from a refined cellulosic material. The term “refined cellulosic material” is used here to refer to a material that is cellulose-based (for example, derived from a plant) but has been processed (for example, refined) to remove compounds, to alter the chemical structure of the material, or both. The removed compounds may be compounds other than water such that the refining process includes steps other than or in addition to drying. Examples of suitable refined cellulosic materials for use in the absorbent carrier include paper, filter paper, paperboard, cardboard, rayon (for example, lyocell, viscose, modal), and the like. According to some embodiments, the absorbent carrier may include other fibrous materials, such as silk, wool, cotton, linen, etc.

The absorbent carrier may have any suitable thickness. For example, the absorbent carrier may have a thickness of about 0.1 mm or greater, about 0.2 mm or greater, about 0.5 mm or greater, or about 1 mm or greater. The absorbent carrier may have a thickness of up to about 5 mm, up to about 4 mm, up to about 3.5 mm, up to about 3 mm, up to about 2.5 mm, or up to about 2 mm. In one embodiment, the absorbent carrier has a thickness from about 0.1 mm to about 3 mm.

The absorbent carrier may have any suitable surface area. For example, the absorbent carrier may have a surface area of about 1 cm² or greater, about 2 cm² or greater, about 3 cm² or greater, about 3.5 cm² or greater, about 4 cm² or greater, about 5 cm² or greater, about 6 cm² or greater, or about 8 cm² or greater. The absorbent carrier may have a surface area of up to about 50 cm², up to about 40 cm², up to about 30 cm², up to about 25 cm², up to about 20 cm², up to about 18 cm², up to about 15 cm², or up to about 10 cm². In one embodiment, the absorbent carrier has a surface area from about 2 cm² to about 10 cm².

The absorbent carrier may also include a layer of thermally conductive or inductive material. For example, the absorbent carrier may be coated or laminated with a thermally conductive or inductive material. Examples of suitable thermally conductive or inductive materials include various metals, such as aluminum, copper, zinc, nickel, silver, stainless steel, or a combination thereof. Suitable inductive susceptor materials may also comprise or be made of graphite, molybdenum, silicon carbide, niobium, INCONEL® alloys (austenitic nickel-chromium-based superalloys), metallized films, ceramics such as for example zirconia, transition metals such as for example Fe, Co, Ni, or metalloids components such as for example B, C, Si, P, Al. Such thermally conductive or inductive materials may act as a thermal bridge and provide more uniform temperature profile. Use of a thermally conductive or inductive material layer may also be advantageous if the absorbent carrier is provided in a rolled-up form.

According to some embodiments, the aerosol-generating article comprises a body defining a cavity and an internal surface. The aerosol-generating article may contain the substrate and the absorbent carrier impregnated or impregnatable with the aerosol former within the cavity. The absorbent carrier may be disposed adjacent the internal surface of the cavity, adjacent a heating element, adjacent the substrate, or any combination thereof. In one embodiment, the absorbent carrier comes in direct contact with a heated surface when the aerosol-generating article is in use. The heating element may be an external heating element or an internal heating element or may include both internal and external heating elements. The aerosol-generating article may include at least 1 g, at least 1.5 g, at least 2 g, or at least 2.5 g of aerosol-forming substrate. The aerosol-generating article may include up to 15 g, up to 10 g; up to 5 g, or up to 4 g of aerosol-forming substrate. The aerosol-generating article may include 0.3 g or greater, 0.5 g or greater, 0.8 g or greater, 1 g or greater, 1.2 g or greater, or 1.5 or greater of aerosol former impregnated or impregnatable into the absorbent carrier. The aerosol-generating article may include up to 8 g, up to 7 g, up to 6 g, up to 5.5 g, up to 5 g, up to 4.5 g, or up to 4 g of aerosol former impregnated or impregnatable into the absorbent carrier. The absorbent carrier may form a sheet disposed adjacent the substrate or surrounding (for example, at least partially surrounding) the substrate, or both. For example, the absorbent carrier may form a sleeve shape with the substrate disposed inside. In one embodiment, the absorbent carrier is disposed as alternating layers (for example, is rolled up) with the substrate. The absorbent carrier may be flat, curved, rolled, folded, pleated, crimped, scrunched, bent, etc., or may include a combination of forms and shapes (for example, a flat portion and a pleated or bent portion).

In some embodiments the aerosol-generating article may include one or more removable seals covering one or more inlets or open ends of the aerosol-generating article. The one or more seals are preferably sufficient to prevent air flow through the inlets or open ends and may be sufficient to prevent leakage of the contents of the aerosol-generating article and to extend shelf life. The seal may comprise a peelable label, sticker, foil, or the like. The label, sticker, or foil may be affixed to the aerosol-generating article in any suitable manner, such as with an adhesive, crimping, welding, or otherwise being joined to the container. The seal may comprise a tab that may be grasped to peel or remove the label, sticker, or foil from the aerosol-generating article.

The aerosol-generating article may be used with any suitable electrically heated aerosol-generating device. Preferably, the aerosol-generating device is configured to sufficiently heat the aerosol-forming substrate in the aerosol-generating article to form an aerosol from the aerosol-forming substrate but not to combust the aerosol-forming substrate. One commercially available aerosol-generating heat-not-burn device is the Philip Morris International IQOS® device, which is configured to receive and heat heatsticks. Some commercially available heatsticks are the Philip Morris International HEETS® or HeatSticks®. HeatSticks comprise a tobacco substrate formed from a crimped tobacco sheet. The IQOS® heating device includes a heating blade that is configured to pierce the tobacco substrate of a heatstick inserted into the device, such that the heating blade contacts and heats the tobacco substrate, primarily via conduction, such that volatile compounds of the aerosol-forming substrate release a vapor that cools to form an aerosol that may be inhaled by a user. According to some embodiments of the present disclosure, the aerosol-generating article of the present invention may be used with an IQOS® device. According to some embodiments of the present disclosure, the aerosol-generating article of the present invention may be used with electrically heated aerosol-generating devices constructed to receive and heat an aerosol-generating article comprising an aerosol-forming substrate plug to generate an aerosol.

In some embodiments, the aerosol-generating device may comprise a housing with a receptacle for receiving the aerosol-generating article. The aerosol-generating article may be shaped as an elongate article and the receptacle may be shaped to accommodate the shape of the aerosol-generating article. The aerosol-generating device may comprise a heating element for heating the aerosol-forming substrate. The heating element may be an external heating element that at least partially circumscribes the aerosol-generating article when the aerosol-generating article is inserted into the receptacle. The heating element may be an elongated element extending into the receptacle and configured to penetrate the aerosol-generating article when the aerosol-generating article is received in the receptacle of the device. The heating element may comprise both an external heating element that at least partially circumscribes the aerosol-generating article when the aerosol-generating article is inserted into the receptacle and also an elongated element extending into the receptacle and configured to penetrate the aerosol-generating article when the aerosol-generating article is received in the receptacle of the device. The heating element may be provided in a cavity, such as a heating chamber.

The absorbent carrier impregnated or impregnatable with the aerosol former may be arranged as part of the aerosol-generating article such that the absorbent carrier is positioned adjacent an internal surface of the heating chamber when the aerosol-generating article is received by the aerosol-generating device. The absorbent carrier impregnated or impregnatable with the aerosol-former may be arranged as part of the aerosol-generating article such that the absorbent carrier is adjacent a surface of a heating element of the aerosol-generating device when the aerosol-generating article is received by the aerosol-generating device. The absorbent carrier impregnated or impregnatable with the aerosol-former may be arranged as part of the aerosol-generating article such that the absorbent carrier is adjacent both an internal surface of the heating chamber and a surface of a heating element of the aerosol-generating device when the aerosol-generating article is received by the aerosol-generating device. The absorbent carrier may be disposed adjacent the aerosol-forming substrate. The absorbent carrier may be disposed between the aerosol-forming substrate and the internal cavity surface, a surface of a heating element, or both. The absorbent carrier may be disposed between the heating element and the aerosol-forming substrate.

In use, when the aerosol-generating article is received in the receptacle of the aerosol-generating device, heat from the heating element of the device may be transferred to the body of the aerosol-generating article. When a user draws on the mouthpiece of the aerosol-generating device, air may be drawn into the receptacle of the device, through one or more air passageways in the body of the device, and through the aerosol-generating article, from a distal end of the aerosol-generating article to a proximal end of the aerosol-generating article. As air passes through the heated aerosol-generating article, volatile compounds in the aerosol former may release a vapor that is entrained in the air. After the aerosol-forming substrate heats to a sufficiently high temperature, the aerosol-forming substrate also releases vapor into the air flowing through the aerosol-generating article. In some embodiments, the aerosol-forming substrate may require heating to a relatively higher temperature than the aerosol former (for example, to a temperature above the vaporization temperature of volatile compounds of the aerosol-forming substrate). In some embodiments, the air is first heated by a heating element. The volatile compounds in the aerosol former and aerosol-forming substrate are heated by the heated air and optionally also by the heating element to release the vapor. The vapor may cool as it is drawn through the article towards the mouthpiece and form an aerosol. The aerosol may then be delivered to the user at the mouthpiece for inhalation.

The heating element may comprise a resistive heating component, such as one or more resistive wires or other resistive elements. The resistive wires may be in contact with a thermally conductive material to distribute heat produced over a broader area. Examples of suitable conductive materials include aluminum, copper, zinc, nickel, silver, and combinations thereof.

The heating element may comprise a susceptor for heating by an inductive element. The inductive element may comprise one or more induction coils configured to induce eddy currents and/or hysteresis losses in a susceptor material, which results in heating of the susceptor. In order to facilitate inductive heating, the aerosol-generating article may be provided with a susceptor. Alternatively, the aerosol-generating device may comprise the susceptor. Alternatively, both the aerosol-generating article and the aerosol-generating device may each comprise a susceptor. Suitable susceptor materials are discussed above.

The aerosol-generating device may comprise control electronics operably coupled to the heating element. Where the heating element comprises a susceptor and inductive element arrangement, the control electronics may be operably coupled to an inductive element. The control electronics may be configured to control heating of the heating element. The control electronics may be configured to control a heating profile over time of the heating element. The control electronics may be provided as part of the aerosol-generating device, for example, internal to the housing.

The control electronics may be provided in any suitable form and may, for example, include a controller or a memory and a controller. The controller may include one or more of an Application Specific Integrated Circuit (ASIC) state machine, a digital signal processor, a gate array, a microprocessor, or equivalent discrete or integrated logic circuitry. Control electronics may include memory that contains instructions that cause one or more components of the circuitry to carry out a function or aspect of the control electronics. Functions attributable to control electronics in this disclosure may be embodied as one or more of software, firmware, and hardware.

The electronic circuitry may comprise a microprocessor, which may be a programmable microprocessor. The electronic circuitry may be configured to regulate a supply of power. The power may be supplied to the heating element or inductive element in the form of pulses of electrical current.

If the heating element is a resistive heating element, the control electronics may be configured to monitor the electrical resistance of the heating element. The control electronics may be configured to control the supply of power to the heating element depending on the electrical resistance of the heating element. In this manner, the control electronics may regulate the temperature of the resistive element.

If the heating components comprise an inductive element and the heating element comprises a susceptor material, the control electronics may be configured to monitor aspect of the induction coil. The control electronics may be configured to control the supply of power to the induction coil depending on the aspects of the coil. In this manner, the control electronics may regulate the temperature of the susceptor material.

The aerosol-generating device may comprise a temperature sensor, such as a thermocouple, operably coupled to the control electronics to control the temperature of the heating element or substrate. The temperature sensor may be positioned in any suitable location. For example, the temperature sensor may be configured to insert into the aerosol generating substrate or in contact or proximity with the heating element. The sensor may transmit signals regarding the sensed temperature to the control electronics, which may adjust heating of the heating elements to achieve a suitable temperature at the sensor.

Regardless of whether the aerosol-generating device includes a temperature sensor, the device is preferably configured to heat an aerosol-forming substrate of an aerosol generating article received by the aerosol-generating device to an extent sufficient to generate an aerosol without combusting the aerosol generating substrate.

The aerosol-generating device may be configured to heat the aerosol-forming substrate to a temperature of at least about 150° C., at least about 180° C., or at least about 200° C. The aerosol-generating device may be configured to heat the aerosol-forming substrate to a temperature of up to about 375° C., up to about 350° C., up to about 300° C., up to about 250° C., or up to about 230° C.

The control electronics may be operably coupled to a power supply. The power supply may be internal to the housing. The aerosol-generating device may comprise any suitable power supply. For example, a power supply of an aerosol-generating device may be a battery or set of batteries. The batteries maybe rechargeable, as well as removable and replaceable. Any suitable battery may be used.

The aerosol-generating article may be a cartridge configured for use in a shisha device. Preferably, the shisha device is configured to sufficiently heat the aerosol-forming substrate in the aerosol-generating article to form an aerosol from the aerosol-forming substrate but not to combust the aerosol-forming substrate. The shisha device may comprise a receptacle for receiving the aerosol-generating article. The shisha device comprises a heating element configured to contact or to be in proximity to the body of the aerosol-generating article when the aerosol-generating article is received in the receptacle. In one example, a shisha device includes an aerosol-generating element that comprises a cartridge receptacle, a heating element, an aerosol outlet, and a fresh air inlet. The cartridge receptacle is configured to receive a cartridge containing the aerosol-forming substrate and the absorbent carrier impregnated with an aerosol former. The heating element may define at least part of a surface of the receptacle.

The shisha device comprises a fresh air inlet channel in fluid connection with the receptacle. In use, when the absorbent carrier inside the cartridge is heated, the impregnated aerosol formers in the absorbent carrier vaporize. Air flowing from the fresh air inlet channel through the cartridge becomes entrained with aerosol generated from the aerosol former components and aerosol-forming substrate in the cartridge.

The shisha device may comprise any suitable vessel defining an interior volume configured to contain a liquid and defining an outlet in the head-space above a liquid fill level. The vessel may be filled with a liquid by a consumer. The liquid preferably comprises water, which may optionally be infused with one or more colorants, flavorants, or colorants and flavorants.

Aerosol entrained in air exiting the aerosol outlet of the receptacle may travel through a conduit positioned in the vessel. The conduit may be coupled to the aerosol outlet of the aerosol generating element of the shisha assembly and may have an opening below the liquid fill level of the vessel, such that aerosol flowing through the vessel flows through the opening of the conduit, then through the liquid, into headspace of the vessel and exits through a headspace outlet, for delivery to a consumer. The headspace outlet may be coupled to a hose comprising a mouthpiece for delivering the aerosol to a consumer.

Reference will now be made to the drawings, which depict one or more aspects described in this disclosure. However, it will be understood that other aspects not depicted in the drawings fall within the scope and spirit of this disclosure. Like numbers used in the figures refer to like components. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components. The figures are presented for purposes of illustration and not limitation. Schematic drawings presented in the figures are not necessarily to scale.

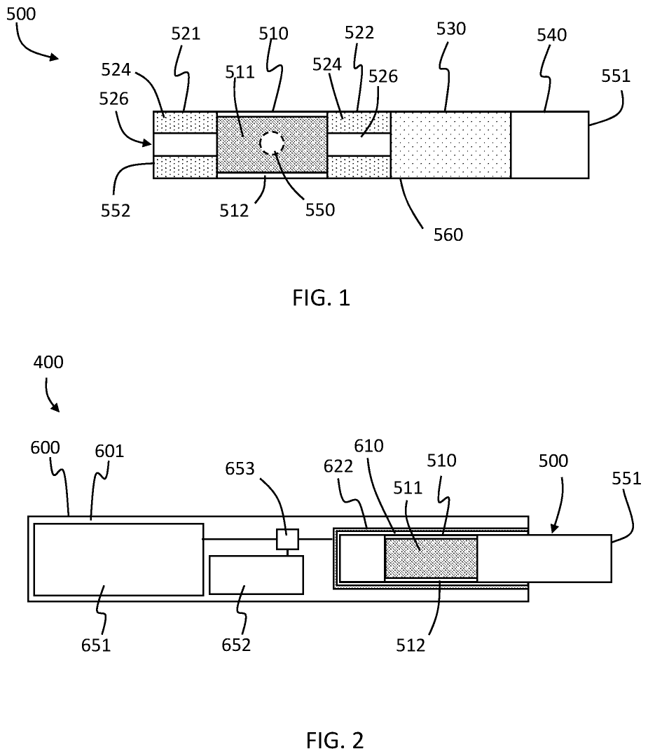

FIG. 1 is a schematic cross-sectional side view of an aerosol-generating article.

FIG. 2 is a schematic cross-sectional side view of an aerosol-generating device with the aerosol-generating article of FIG. 1 inserted therein.

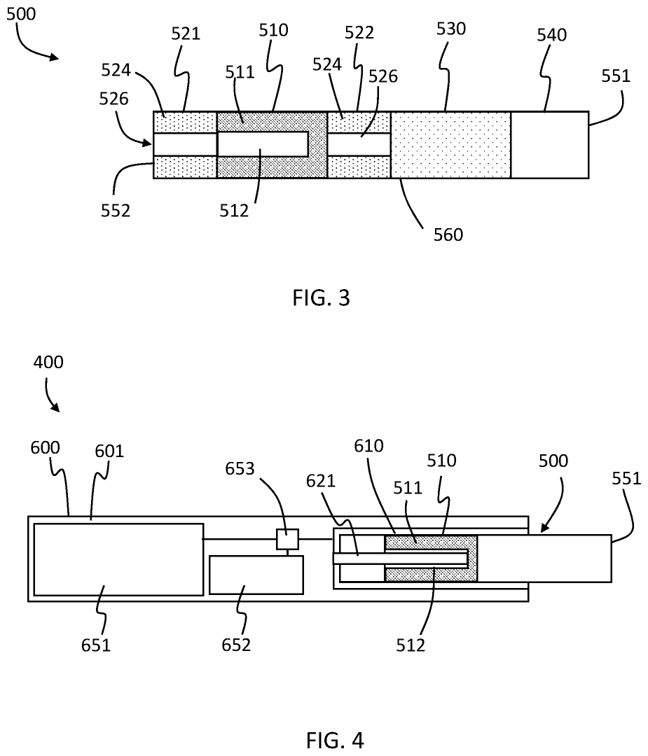

FIG. 3 is a schematic cross-sectional side view of an aerosol-generating article.

FIG. 4 is a schematic cross-sectional side view of an aerosol-generating device with the aerosol-generating article of FIG. 3 inserted therein.

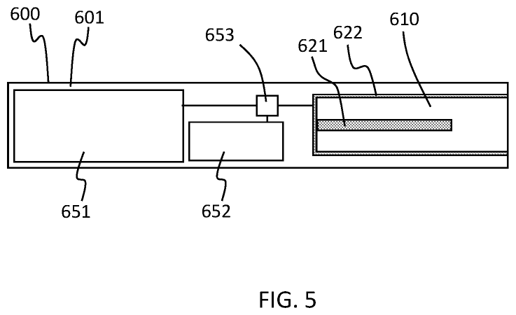

FIG. 5 is a schematic cross-sectional side view of an aerosol-generating device with an external heating element and an internal heating element.

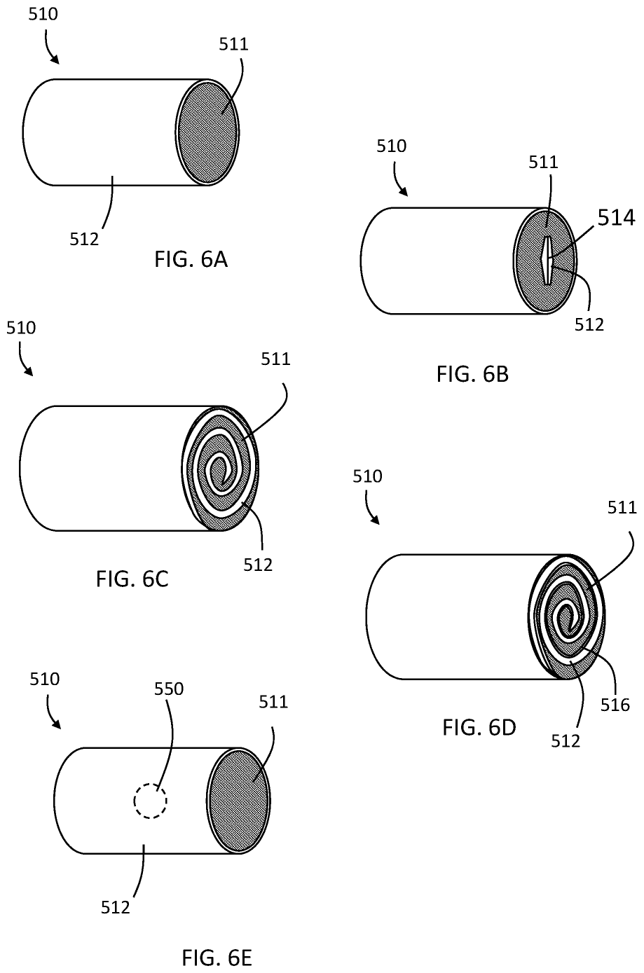

FIGS. 6A-6E are schematic perspective views of a substrate section of an aerosol-generating article.

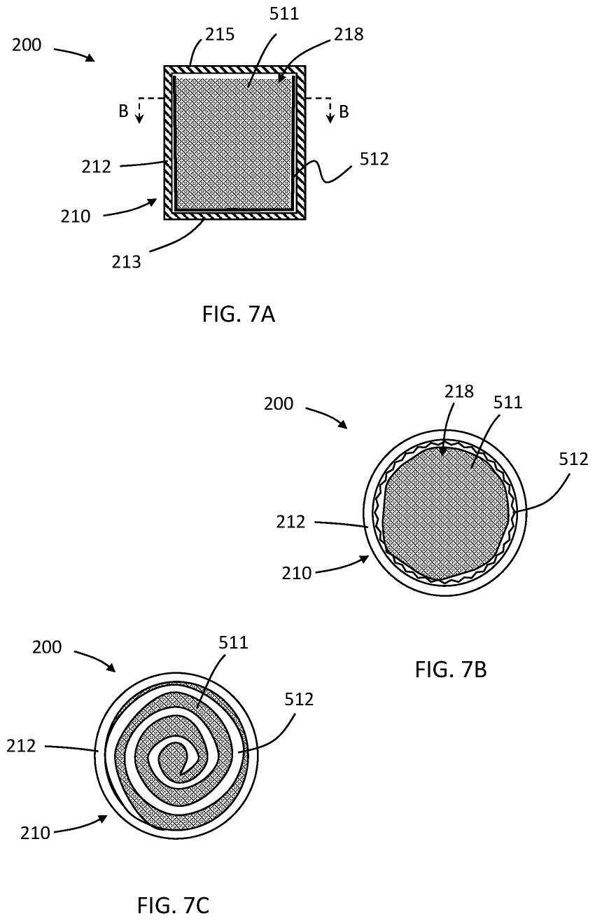

FIG. 7A is a cross sectional side view of an aerosol-generating article configured as a cartridge.

FIG. 7B is a cross sectional top view of an aerosol-generating article configured as a cartridge.

FIG. 7C is a cross sectional top view of an aerosol-generating article configured as a cartridge.

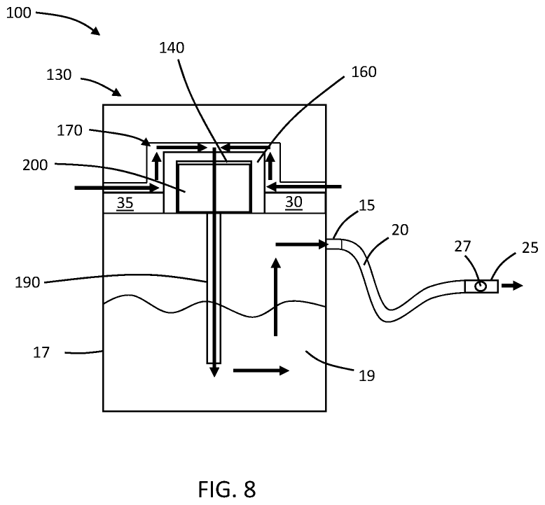

FIG. 8 is a schematic sectional view of a shisha device.

FIG. 1 is a schematic cross-sectional side view of an exemplary aerosol-generating article 500 according to an embodiment. The aerosol-generating article 500 shown comprises multiple coaxial elements. However, many of the elements are optional or preferred, and the aerosol-generating article 500 may be made with or without them. The aerosol-generating article 500 includes at least a substrate element 510 that comprises the aerosol-forming substrate 511, absorbent carrier 512, and aerosol former impregnated or impregnatable in the absorbent carrier 512. The aerosol-generating article 500 may also include one or more support elements 521, 522 disposed adjacent the substrate element 510. The first support element 521 may be located at the extreme distal or upstream end 552 of the aerosol-generating article. The second support element 522 may be located at the opposite side and immediately downstream of the substrate element 510. The support elements 521, 522 may be used to help maintain the aerosol-forming substrate 511 in its intended location within the substrate element 510. The support elements 521, 522 may be permeable to air or may include an air path 526 through a tubular element 524 to allow airflow through the aerosol-generating article 500. The support elements 521, 522 may be made from any suitable material, such as cellulose acetate.

The aerosol-generating article 500 may optionally comprise a capsule 550 embedded into the substrate element 510. The capsule 550 may comprise aerosol former. The capsule 550 may be ruptured by a user prior to use of the aerosol-generating article 500 to release the aerosol former and to impregnate the absorbent carrier 512 with the aerosol former.

The aerosol-generating article 500 may comprise an aerosol-cooling element 530. The aerosol-cooling element 530 may be located downstream of the substrate element 510 and the optional support element 522. In use, volatile substances released from the substrate element 510 pass through the aerosol-cooling element 530 towards the mouth end 551 of the aerosol-generating article 500. The volatile substances may cool within the aerosol-cooling element 530 to form an aerosol that may be inhaled by the user.

The aerosol-cooling element 530 may be made from any suitable material, such as a crimped and gathered sheet material that provides a plurality of longitudinal channels extending along the length of the aerosol-cooling element 530. One example of a suitable material for the aerosol-cooling element 530 is a sheet of polylactic acid. The sheet of polylactic acid may be crimped.

The aerosol-generating article 500 may further include a mouthpiece 540 located immediately downstream of and abutting the aerosol-cooling element 530. The mouthpiece 540 may comprise a filter. An example of a suitable filter is conventional cellulose acetate tow filter.

The elements of the aerosol-generating article 500 may be circumscribed by an outer wrapper, wall, or sleeve 560 to maintain the elements in place.

The aerosol-generating article 500 has a proximal, downstream or mouth end 551 for insertion into the mouth of a user, and an upstream or distal end 552 located at the opposite end of the mouth end 551. The aerosol-generating article 500 and each of its elements may be substantially cylindrical, each having substantially the same diameter. For example, the aerosol generating article 500, the support elements 521, 522, the substrate element 510, the cooling element 530 and the mouthpiece 540 may be substantially cylindrical and may each have substantially the same diameter. The elements may be arranged sequentially to form a cylindrical rod. The elements may be circumscribed by an outer wrapper 560.

To assemble the aerosol-generating article 500, the elements are aligned and tightly wrapped within an outer wrapper. The outer wrapper may be a conventional cigarette paper. Once assembled, the total length of the aerosol-generating article 500 may be about 40 mm to about 60 mm, or from about 45 mm to about 53 mm, and the diameter may be from about 6.5 mm to about 8 mm, or about 7.2 mm.

Referring now to FIG. 2, the aerosol-generating article 500 may be inserted into an aerosol-generating device 600. The aerosol-generating article 500 and the aerosol-generating device 600 together may form an aerosol-generating system 400.

The aerosol-generating device 600 shown in FIG. 2 is configured for receiving the aerosol-generating article 500 of FIG. 1. The aerosol-generating device 600 comprises a housing 601 and a receptacle 610 formed in the housing 601. The receptacle 610 is constructed for receiving the aerosol-generating article 500. The receptacle 610 may be sized and shaped so that when the aerosol-generating article 500 is inserted in the receptacle 610, at least a portion (for example the mouthpiece 540) of the aerosol-generating article 500 remains outside of the receptacle 610.

The aerosol-generating system 400 comprises a heating element. As shown in FIG. 2, the heating element may be an external heating element 622. An external heating element 622 may either be a part of the aerosol-generating article 500 or may be mounted along the inside walls of the receptacle 610 of the aerosol-generating device 600. In use, when the user inserts the aerosol-generating article 500 into the receptacle 610 of the aerosol-generating device 600, the heating element 622 at least partially circumscribes the aerosol-forming substrate 511 of the aerosol-generating article 500 as shown in FIG. 2.

Referring now to FIG. 3, an aerosol-generating article 500 configured for use with an internal heating element is shown. The aerosol-generating article 500 shown comprises multiple coaxial elements. However, many of the elements are optional or preferred, and the aerosol-generating article 500 may be made with or without them. The aerosol-generating article 500 includes at least a substrate element 510 that comprises the aerosol-forming substrate 511, absorbent carrier 512, and aerosol former impregnated or impregnatable in the absorbent carrier 512. In the embodiment shown, the absorbent carrier 512 forms a core disposed in the center of the substrate element 510 and is surrounded by the aerosol-forming substrate 511. The absorbent carrier 512 may form a slot constructed to receive an internal heating element.

The aerosol-generating article 500 may also include one or more support elements 521, 522 disposed adjacent the substrate element 510. The first support element 521 may be located at the extreme distal or upstream end 552 of the aerosol-generating article. The second support element 522 may be located at the opposite side and immediately downstream of the substrate element 510. The support elements 521, 522 may be used to help maintain the aerosol-forming substrate 511 in its intended location within the substrate element 510. The support elements 521, 522 may be permeable to air or may include an air path 526 through a tubular element 524 to allow airflow through the aerosol-generating article 500. The support elements 521, 522 may be made from any suitable material, such as cellulose acetate.

The aerosol-generating article 500 may comprise an aerosol-cooling element 530, a mouthpiece 540, and an outer wrapper, wall, or sleeve 560 similar to that shown in FIG. 1. The aerosol-generating article 500 may be assembled similar to the aerosol-generating article 500 of FIG. 1. The aerosol-generating article 500 may have a similar generally cylindrical shape as the aerosol-generating article 500 of FIG. 1.

FIG. 4 shows an exemplary aerosol-generating system 400 comprising an aerosol-generating device 600 and the aerosol-generating article 500 of FIG. 3. The aerosol-generating device 600 shown in FIG. 4 comprises a housing 601 and a receptacle 610 formed in the housing 601. The receptacle 610 is constructed for receiving the aerosol-generating article 500. The receptacle 610 may be sized and shaped so that when the aerosol-generating article 500 is inserted in the receptacle 610, at least a portion (for example the mouthpiece 540) of the aerosol-generating article 500 remains outside of the receptacle 610.

The aerosol-generating system 400 of FIG. 4 comprises an internal heating element 621. An internal heating element 621 may either be a part of the aerosol-generating article 500 or may be mounted within the receptacle 610 of the aerosol-generating device 600. In use, the user inserts the aerosol-generating article 500 into the receptacle 610 of the aerosol-generating device 600 such that the internal heating element 621 is inside the aerosol-forming substrate 511 of the aerosol-generating article 500 as shown in FIG. 4. In the embodiment shown in FIG. 4, the internal heating element 621 is a heater blade.

If the internal heating element 621 is mounted within the receptacle 610, inserting the aerosol-generating article 500 into the receptacle 610 may cause a certain amount of penetration force experienced by the aerosol-generating article 500 during insertion. The second support element 522 of the aerosol-generating article 500 resists the penetration force of the internal heating element 621 and thereby resists downstream movement of the aerosol-forming substrate 511 within the aerosol-generating article 500 during insertion of the internal heating element 621 of the aerosol-generating device 600 into the aerosol-forming substrate 511.

FIG. 5 shows an aerosol-generating device 600 that includes both an internal heating element 621 and an external heating element 622.

The aerosol-generating device 600 as shown in FIGS. 2, 4 and 5 comprises a power supply 651 and electronics 652, 653 that allow the heating element 621, 622 to be actuated. Such actuation may be manually operated or may occur automatically in response to a user drawing on an aerosol-generating article 500 inserted into the aerosol-generating article the receptacle 610 of the aerosol-generating device 600. One or more openings may be provided in the aerosol-generating device 600 to allow air to flow to the aerosol-generating article 500.

The electronics may include a controller 652 and a user interface 653. The controller 652 may be operably connected to the heating element 621, 622, the power supply 651, and the user interface 653. The user interface 653 may include, for example, a button, a display, or both. The controller 652 controls the power supplied to the heating element 621, 622 in order to regulate its temperature. The power supply 651 may be an electrical energy supply, for example a rechargeable lithium ion battery. The electronics may further include a temperature control.

Preferably, in the various embodiments, the absorbent carrier 512 impregnated or impregnatable with an aerosol former is disposed between the heating element 621, 622 and the aerosol-forming substrate 511. Initially, once the aerosol-generating article 500 is inserted into the receptacle 610 and the heating element 621, 622 is actuated, the temperature of the substrate element 510 begins to rise. Because the absorbent carrier is nearest to the heating element (for example, disposed between the heating element and the substrate), the aerosol former impregnated in the absorbent carrier 512 reaches its volatilization temperature first before the aerosol-forming substrate. At this temperature, volatile compounds are evolved from the aerosol former. The temperature of the aerosol-forming substrate continues to rise until it reaches a target temperature, such as a temperature of approximately 375 degrees Celsius. The aerosol-forming substrate also begins to release vapor upon reaching a temperature above the vaporization temperature of volatile compounds in the aerosol-forming substrate. As a user draws on the mouth end 70 of the aerosol-generating article 500, the volatile compounds evolved from the aerosol former impregnated in the absorbent carrier 512 are drawn downstream through the aerosol-generating article 500 and condense to form an aerosol that is drawn through the mouthpiece 50 of the aerosol-generating article 500 into the user's mouth. After a short while (for example after the first few puffs), the aerosol-forming substrate 511 also heats to a sufficient temperature to also release aerosols from the aerosol-forming substrate 511 itself.

As the aerosol passes downstream thorough the aerosol-cooling element 530, the temperature of the aerosol is reduced due to transfer of thermal energy from the aerosol to the aerosol-cooling element 530. When the aerosol enters the aerosol-cooling element 530, its temperature is approximately 60 degrees Celsius. Due to cooling within the aerosol-cooling element 530, the temperature of the aerosol as it exits the aerosol-cooling element is approximately 40 degrees Celsius.

FIGS. 6A-6E show various embodiments of the substrate element 510 that comprises the aerosol-forming substrate 511, absorbent carrier 512, and aerosol former impregnated or impregnatable in the absorbent carrier 512. The substrate elements 510 of FIGS. 6A-6E may be used with any suitable aerosol-generating device, including but not limited to those shown in FIGS. 2, 4, 5, and 8. In a first embodiment shown in FIG. 6A, the substrate element 510 includes a core of aerosol-forming substrate 511 surrounded by the absorbent carrier 512 impregnated with the aerosol former. The first embodiment is particularly suitable for use with an external heating element that at least partially circumscribes the substrate element 510.

In a second embodiment shown in FIG. 6B, the substrate element 510 includes aerosol-forming substrate 511 and at the center of the aerosol-forming substrate 511, the absorbent carrier 512 impregnated with the aerosol former. The second embodiment is particularly suitable for use with an internal heating element that penetrates the substrate element 510. The absorbent carrier 512 may form a slot constructed to receive an internal heating element. The substrate element 510 may also comprise a susceptor. An optional susceptor is shown as a susceptor blade 514 disposed adjacent the absorbent carrier 512 in FIG. 6B.

In a third embodiment shown in FIG. 6C, the substrate element 510 includes a spiral of a plurality of alternating layers of absorbent carrier 512 and aerosol-forming substrate 511 impregnated with the aerosol former. The substrate element 510 of FIG. 6C could be used, for example, with the aerosol-generating device 600 of FIG. 5.

In a fourth embodiment shown in FIG. 6D, the substrate element 510 includes a spiral of alternating layers of absorbent carrier 512 and aerosol-forming substrate 511 impregnated with the aerosol former, and a susceptor material layer 516. The susceptor material layer 516 may be layered with or laminated onto the layer of absorbent carrier 512. The substrate element 510 of FIG. 6D could be used, for example, with the aerosol-generating device 600 of FIG. 5.

In a fifth embodiment shown in FIG. 6E, the substrate element 510 includes a core of aerosol-forming substrate 511 surrounded by the absorbent carrier 512 impregnatable with the aerosol former. The aerosol former is included in a capsule 550 embedded into the substrate element 510. The capsule 550 may be ruptured by a user prior to use of the aerosol-generating article 500 to release the aerosol former and to impregnate the absorbent carrier 512 with the aerosol former.

The substrate element 510 may also include combinations of the five embodiments shown in the figures. For example, the substrate element 510 may include a combination of features of FIGS. 6A and 6B or FIGS. 6A and 6C, FIGS. 6A and 6D, FIGS. 6A and 6E, or FIGS. 6B and 6C, FIGS. 6B and 6D, FIGS. 6B and 6E, or FIGS. 6C and 6E, or FIGS. 6D and 6E, or indeed any combination of any two, three or four of FIGS. 6A to 6E.

Referring to FIGS. 7A and 7B, the aerosol-generating article 500 may be configured as a cartridge. For example, the substrate elements shown in FIGS. 6A-6E may be provided with a body of a cartridge. A cartridge 200 has a body 210 defining a cavity 218 in which an aerosol-forming substrate 511 and absorbent carrier 512 impregnated with an aerosol former may be disposed. The body 210 includes a top 215, bottom 213, and a sidewall 212. The body 210 may be formed from one or more parts. For example, the top 215 or bottom 213 may be removably attached from the sidewall 212 to allow the aerosol-forming substrate 511 and absorbent carrier 512 to be disposed in the cavity 218. The absorbent carrier 512 may be disposed along the side wall 212 or the side wall 212and the bottom 213 of the cavity 218. The absorbent carrier 512 may also be disposed along the top 215, or along any combination of the bottom 213, the top 215, or the side wall 212, or may cover any of these surfaces in part. In the example shown, the absorbent carrier 512 has pleated sides that surround the perimeter of the aerosol-forming substrate 511.

FIG. 7C shows a cross sectional view of a cartridge 200 where the aerosol-forming substrate 511 and absorbent carrier 512 form a spiral cylinder shape that includes a plurality of alternating layers of absorbent carrier 512 and aerosol-forming substrate 511. The rolled-up cylindrical shape is disposed inside the body 210 of the cartridge 200.

The cartridge 200 has a heatable surface area inside the cavity 218, which is a surface capable of transferring heat applied to the exterior of the body, for example, by a heating element of an aerosol-generating device, to the absorbent carrier 512 and the aerosol-forming substrate 511 in the cavity 218.

The top 215 and bottom 213 of the body may have a plurality of apertures to allow air flow through the cartridge 200, when the cartridge is in use. The cartridge 200 may also or alternatively include apertures along the sidewall 212. The absorbent carrier 512 may be disposed along the bottom 213, the top 215, the side wall 212, or a combination thereof, covering some or all of the apertures. The apertures may further be blocked by a peelable seal or cover when the cartridge is stored prior to use.

In some embodiments, an aerosol-generating article 500 configured as a cartridge is configured for use in a shisha device. FIG. 8 is a schematic sectional view of an example of an aerosol-generating system that includes a shisha device 100. The shisha device 100 includes a vessel 17 defining an interior volume configured to contain liquid 19 and defining a headspace outlet 15 above a fill level for the liquid 19. The liquid 19 preferably comprises water, which may optionally be infused with one or more colorants, one or more flavorants, or one or more colorants and one or more flavorants. For example, the water may be infused with one or both of botanical infusions or herbal infusions.

The device 100 also includes an aerosol-generating element 130. The aerosol-generating element 130 includes a receptacle 140 configured to receive an aerosol-generating article provided as a cartridge 200, containing an aerosol-forming substrate and an absorbent carrier forming a sheet and impregnated with an aerosol former. The aerosol-generating element 130 also includes a heating element 160 that forms at least one surface of the receptacle 140. In the depicted embodiment, the heating element 160 defines the top and side surfaces of the receptacle 140. The aerosol-generating element 130 also includes a fresh air inlet channel 170 that draws fresh air into the device 100. In some embodiments, portion of the fresh air inlet channel 170 is formed by the heating element 160 to heat the air before the air enters the receptacle 140. The pre-heated air then enters the cartridge 200, which is also heated by heating element 160, to carry aerosol generated by the aerosol former and the aerosol-forming substrate. The air exits an outlet of the aerosol-generating element 130 and enters a conduit 190.

The conduit 190 carries the air and aerosol into the vessel 17 below the level of the liquid 19. The air and aerosol may bubble through the liquid 19 and exit the headspace outlet 15 of the vessel 17. A hose 20 may be attached to the headspace outlet 15 to carry the aerosol to the mouth of a user. A mouthpiece 25 may be attached to, or form a part of, the hose 20.

An exemplary air flow path of the device, in use, is depicted by thick arrows in FIG. 8.

The mouthpiece 25 may include an activation element 27. The activation element 27 may be a switch, button or the like, or may be a puff sensor or the like. The activation element 27 may be placed at any other suitable location of the device 100. The activation element 27 may be in wireless communication with the control electronics 30 to place the device 100 in condition for use or to cause control electronics to activate the heating element 160; for example, by causing power supply 35 to energize the heating element 140.

The control electronics 30 and power supply 35 may be located in any suitable position of the aerosol generating element 130 other than the bottom portion of the element 130 as depicted in FIG. 8.

The specific embodiments described above are intended to illustrate the invention. However, other embodiments may be made without departing from the scope of the invention as defined in the claims, and it is to be understood that the specific embodiments described above are not intended to be limiting.

As used herein, the singular forms “a,” “an,” and “the” encompass embodiments having plural referents, unless the content clearly dictates otherwise.

As used herein, “or” is generally employed in its sense including “and/or” unless the content clearly dictates otherwise. The term “and/or” means one or all the listed elements or a combination of any two or more of the listed elements.

As used herein, “have,” “having,” “include,” “including,” “comprise,” “comprising” or the like are used in their open-ended sense, and generally mean “including, but not limited to”. It will be understood that “consisting essentially of,” “consisting of,” and the like are subsumed in “comprising,” and the like.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

The term “substantially” as used here has the same meaning as “significantly,” and can be understood to modify the term that follows by at least about 90%, at least about 95%, or at least about 98%. The term “not substantially” as used here has the same meaning as “not significantly,” and can be understood to have the inverse meaning of “substantially,” i.e., modifying the term that follows by not more than 10%, not more than 5%, or not more than 2%.

Any direction referred to herein, such as “top,” “bottom,” “left,” “right,” “upper,” “lower,” and other directions or orientations are described herein for clarity and brevity are not intended to be limiting of an actual device or system. Devices and systems described herein may be used in a number of directions and orientations.

Thus, aerosol-generating articles for aerosol-generating devices are described. Various modifications and variations of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the mechanical arts, chemical arts, and aerosol generating article manufacturing or related fields are intended to be within the scope of the following claims.

1-14. (canceled)

15. An aerosol-generating system comprising:
an aerosol-generating article comprising:
an aerosol-forming substrate;
an absorbent carrier forming a sheet comprising a heating-element contact surface, wherein the absorbent carrier at least partially surrounds the aerosol-forming substrate; and
an aerosol former for impregnating into the absorbent carrier;
an aerosol-generating device for receiving the aerosol-generating article; and
a heating element for heating the aerosol-forming substrate of the aerosol-generating article, the heating element comprising an external heating element that at least partially circumscribes the aerosol-generating article when the aerosol-generating article is received in the aerosol-generating device,
wherein the system is configured such that when the article is received by the aerosol-generating device, the absorbent carrier is disposed between the aerosol-forming substrate and the heating element and the heating-element contact surface contacts the external heating element.

16. An aerosol-generating system according to claim 15, wherein the aerosol-generating article further comprises the heating element.

17. An aerosol-generating system according to claim 15, wherein the aerosol-generating device comprises the heating element.

18. An aerosol-generating system according to claim 15, wherein both the aerosol-generating article and the aerosol-generating device comprise the heating element

19. An aerosol-generating system according to claim 15, wherein the heating element comprises a susceptor, and wherein the aerosol-generating device comprises an inductive coil configured to heat the susceptor when the article is received in the device.

20. An aerosol generating article for use in the aerosol-generating system of claim 15, wherein the aerosol former is impregnated into the absorbent carrier.

21. An aerosol generating article according to claim 15, wherein the aerosol-generating article comprises a frangible membrane that houses the aerosol-former, and wherein the frangible membrane is arranged to release the aerosol-former into the absorbent carrier when the frangible membrane is ruptured.

22. An aerosol generating article according to claim 15, wherein the aerosol-forming substrate comprises a solid, paste, gel, slurry, liquid, or a combination thereof.

23. An aerosol generating article according to claim 15, wherein the aerosol-forming substrate comprises a solid.

24. An aerosol generating article according to claim 15, wherein the aerosol-forming substrate forms a core and wherein the absorbent carrier comprises a cylindrical portion at least partially circumscribing at least a portion of the core.

25. An aerosol generating article according to claim 15, wherein the aerosol-forming substrate forms a layer coated onto the absorbent carrier, and wherein the absorbent carrier and the aerosol-forming substrate form a spiral of alternating layers of absorbent carrier and aerosol-forming substrate.

26. An aerosol generating article according to claim 15, wherein the absorbent carrier is lined with a thermally conductive or inductive material.

27. An aerosol generating article according to claim 15, wherein the absorbent carrier comprises paper.

28. An aerosol generating article according to claim 15, wherein the article comprises a cartridge housing and the aerosol-forming substrate and absorbent carrier are provided within the cartridge housing.

29. An aerosol generating article according to claim 15, wherein the article comprises a susceptor.

30. An aerosol-generating article comprising:
an aerosol-forming substrate;
an absorbent carrier;
an aerosol former for impregnating into the absorbent carrier; and
a heating element,
wherein the absorbent carrier is disposed between the aerosol-forming substrate and the heating element.
